(19) United States
(12) Patent Application Publication
(10) Pub. No.: US 2026/0343684 A1
(43) Pub. Date: Oct. 29, 2026

(54) Food warming board

(71) Applicant: Zhejiang Haoda Electrical Appliance Co., Ltd., Shaoxing City (CN)

(72) Inventors: Zhibiao Wu, Shaoxing City (CN); Zaishan Shu, Shaoxing City (CN)

(73) Assignee: Zhejiang Haoda Electrical Appliance Co., Ltd., Shaoxing City (CN)

(21) Appl. No.: 19/245,390

(22) Filed: Jun. 22, 2025

(30) Foreign Application Priority Data
Feb. 24, 2025 (CN) 2025102019782

(51) Int. Cl. H05B 3/68; H05B 3/28

(52) U.S. Cl. CPC H05B 3/68; H05B 3/28

(57) ABSTRACT

A food warming board, comprise: first heating portions, wherein the first heating portions comprise first vertical portions arranged in parallel with each other and first connecting portions connected between adjacent first vertical portions; a second heating portion, wherein the second heating portions comprise second vertical portions arranged in parallel with each other and second connecting portions connected between adjacent second vertical portions, the first vertical portions and the second vertical portions are perpendicular to a curling direction of the heating plate body, first heating proximal end portions and the second heating proximal end portions are close to the control box of the food warming board, the first heating distal end portions and the second heating distal end portions are far from the control box of the food warming board, and the first heating distal end portions are connected to the second heating distal end portions.

### CROSS-REFERENCE

This application claims the benefit of priority from China Patent Application No. CN 2025102019782 filed on Feb. 24 2025, the contents of which are hereby incorporated by reference in their entirety.

### TECHNICAL FIELD

The present invention belongs to the technical field of heating plates and specifically relates to a food warming board.

### BACKGROUND TECHNOLOGY

The existing flexible food warming boards use silicone as the main bodies, and the heating wires are contacted and fixed on the silicone bodies. The heat of the heating wires is transferred to the silicone panels to achieve the function of warming the food. However, when the existing flexible food warming boards are curled, a large length of the heating wires is curled, which will affect the service life of the heating wires.

### SUMMARY OF THE INVENTION

The purpose of the present invention is to provide a food warming board to prevent the curling of a long length of heating wire and to increase the service life of the heating wires.

To achieve the above purpose, the present invention provides following technical solutions: a food warming board comprises: a heating plate body, wherein heating wires are installed in the heating plate body and the heating wires comprise:
first heating portions, wherein the first heating portions comprise first vertical portions arranged in parallel mutually and first connecting portions connected between adjacent first vertical portions, the first vertical portions are perpendicular to a curling direction of the heating plate body, the first heating portions comprise first heating proximal end potions and first heating distal end portions, the first heating proximal end portions are close to a control box of the food warming board, and the first heating distal end portions are far away from the control box of the food warming board; and
second heating portions, wherein the second heating portions comprise second vertical portions arranged in parallel mutually and second connecting portions connected between adjacent second vertical portions, the second vertical portions are perpendicular to the curling direction of the heating plate body, the second heating portions comprise second heating proximal end portions and second heating distal end portions, the second heating proximal end portions are close to the control box of the food warming board, the second heating distal end portions are far away from the control box of the food warming board, and the first heating distal end portions are connected to the second heating distal end portions.

Further, the heating wires are embedded in the heating plate body, and the heating wires and the heating plate body are integrally formed.

Further, an upper side of the heating plate body is provided with winding grooves with openings facing upward, shapes of the winding grooves correspond to shapes of the heating wires, the heating wires are installed in the winding grooves, and heat conducting sheets in contact with the heating wires are fixed on the upper side of the heating plate body.

Further, the heat conducting sheets are provided with flanges around circumference thereof, and the upper side of the heating plate body is provided with first gluing grooves corresponding to the flanges, the flanges are plugged into the first gluing grooves, and the flanges are fixed in the first gluing grooves by glue.

Further, the upper side of the heating plate body is provided with grooves corresponding to the heat conducting sheets, the heat conducting sheets are plugged into the grooves, and upper sides of the heat conducting sheets and upper sides of the heating plate body are in a same plane.

Further, the heat conducting sheets are arranged in sequence along the curling direction of the heating plate body.

Further, a lower side of the heating plate body is provided with wire passing grooves which are communicated with the winding grooves.

Further, the heating plate body comprises:
a lower silicone plate, wherein an upper side of the lower silicone plate is provided with lower winding grooves, shapes of the lower winding grooves correspond to shapes of the heating wires, and the heating wires are installed in the lower winding grooves; and
an upper silicone plate, wherein the upper silicone plate is fixed to the upper side of the lower silicone plate, the heating wires abut against a lower side of the upper silicone plate.

Further, two second gluing grooves are provided on the lower side of the upper silicone plate, and the two second gluing grooves are located on both sides of the lower winding grooves, glue is installed in the two second gluing grooves, and the upper silicone plate and the lower silicone plate are fixed together by glue.

Further, supporting feet are fixed on a lower side of the heating plate body.

Compared with the prior art, the present invention has the following beneficial effects:
I. Since the first vertical portions and the second vertical portions are perpendicular to a curling direction “A” of the heating plate body, the first vertical portions and the second vertical portions will not be curled during the curling process of the heating plate body, thereby avoiding the curling of a large length of the heating wires, increasing the service life of the heating wires, and making it easy to achieve the curling operation, thereby improving the user experience.
II. Since the heating wires are directly fixed (embedded) in the heating plate body (the heating wires and the heating plate body are integrated), no additional gluing or other methods are required to fix it, so there is no gaps between the first heating wires and the silicone body, the product is more beautiful, and the production cost is low.
III. Since the heat conducting sheets are in direct contact with the heating wires, the heat conducting sheets have high heat conduction efficiency, can withstand higher temperatures, and the heating temperature of the entire warm food plate can be increased, thereby improving the user experience.
IV. When the heating wires are installed in the winding grooves, the heating wires will protrude out of the winding grooves, and the upper silicone plate is fixed on the upper side of the lower silicone plate. Since both the upper silicone plate and the lower silicone plate have certain elasticity, the heating wires are ensured to be in close contact with the lower side of the upper silicone plate.

### BRIEF DESCRIPTION OF THE DRAWINGS

FIG. 1 is a structural schematic diagram of a food warming board in a first

FIG. 2 is a partial enlarged view of point “I” in FIG. 1.

FIG. 3 is a structural schematic diagram of FIG. 1 from another angle.

FIG. 4 is an exploded view of a heating plate body, heating wires and heat conducting sheets of the food warming board in FIG. 1.

FIG. 5 is a partial enlarged view of point “II” in FIG. 4.

FIG. 6 is a cross-sectional view of the connection between the heating plate body, heating wires and heat conducting sheets of the food warming board.

FIG. 7 is a structural schematic diagram of the food warming board when curled.

FIG. 8 is a cross-sectional view of a food warming board in a second embodiment.

FIG. 9 is a structural schematic diagram of a silicone plate of a food warming board in a third embodiment.

FIG. 10 is a cross-sectional view of a silicone plate of a food warming board in a fourth embodiment.

The markups in the drawings are indicated as follows:
1—heating plate body;
2—supporting foot;
31—first heating portion;
311—first vertical portion;
312—first connecting portion;
313—first heating proximal end potion;
314—first heating distal end portion;
32—second heating portion;
321—second vertical portion;
322—second connecting portion;
323—second heating proximal end portion;
324—second heating distal end portion;
4—control box;
5—winding groove;
6—heat conducting sheet;
7—flange;
9—groove;
10—wire passing groove;
11—lower silicone plate;
12—lower winding groove;
13—upper silicone plate;
14—second gluing groove; and
15—outer glue groove.

### SPECIFIC EMBODIMENTS

The following will be combined with the drawings in the embodiments of the present invention to clearly and completely describe the technical solutions in the embodiments of the present invention. Obviously, the described embodiments are only some of the embodiments of the present invention, not all of the embodiments. Based on the embodiments of the present invention, all other embodiments obtained by ordinary technicians in this field without creative work are within the scope of protection of the present invention.

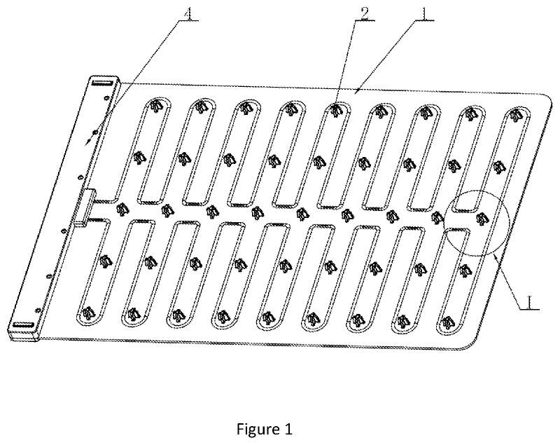

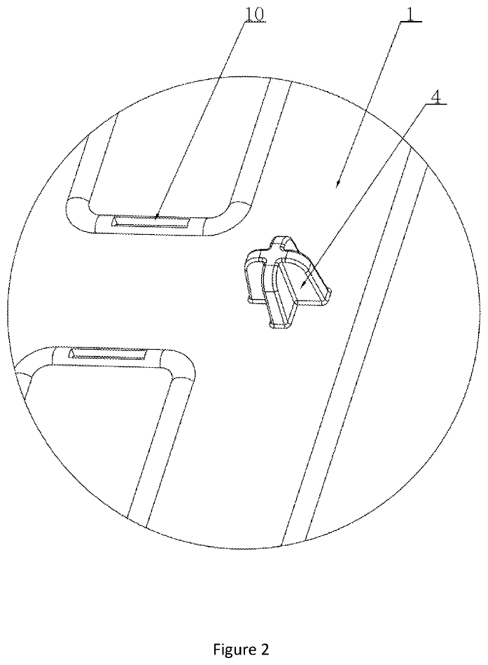

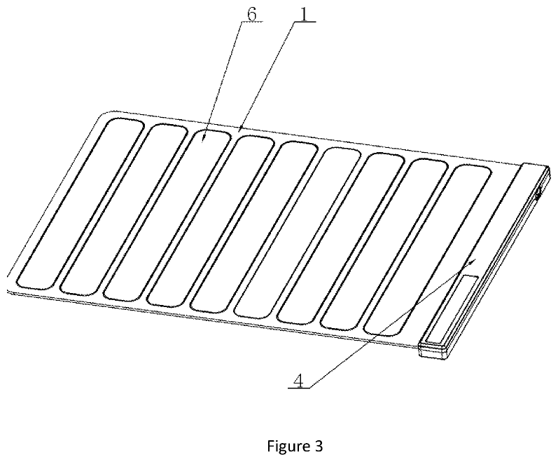

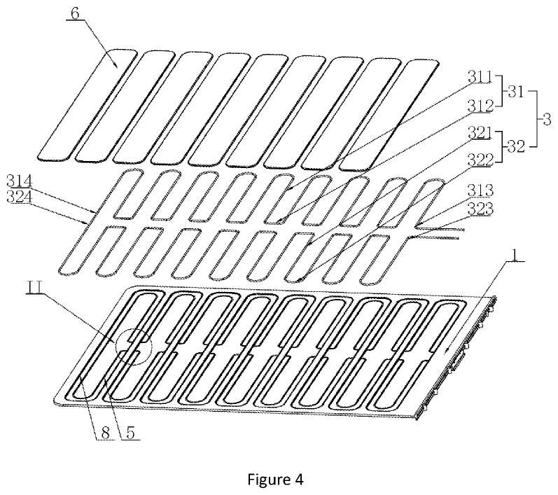

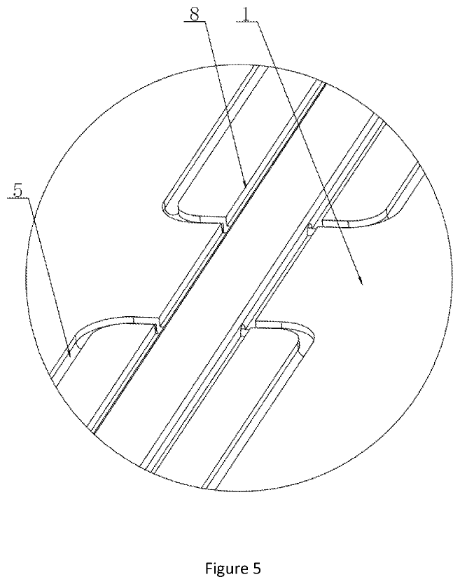

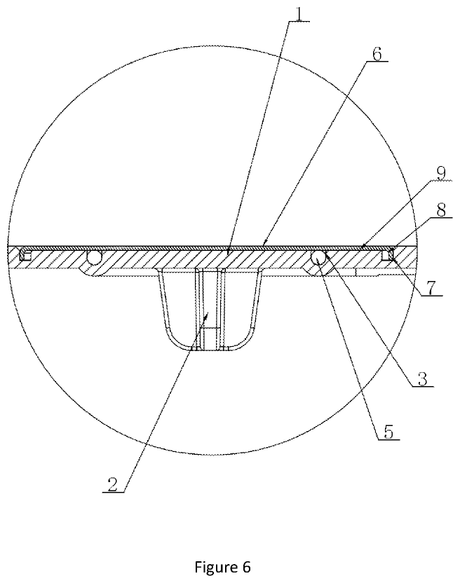

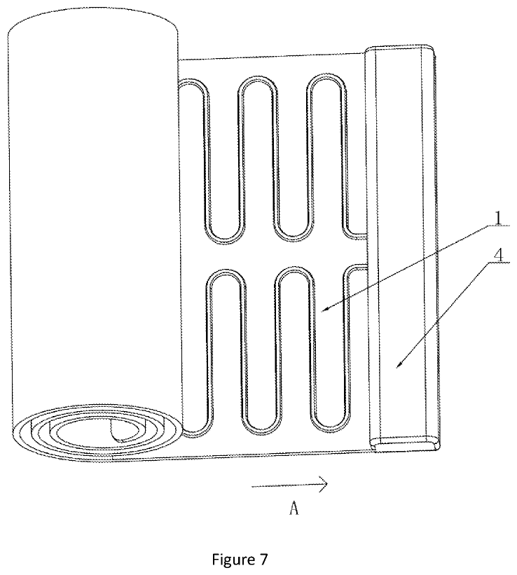

Please refer to FIGS. 1-10, the present invention provides a technical solution of a food warming board, comprising: a heating plate body 1, wherein heating wires 3 are installed in the heating plate body 1 and the heating wires 3 comprise:
first heating portions 31, wherein the first heating portions 31 comprise first vertical portions 311 arranged in parallel mutually and first connecting portions 312 connected between adjacent first vertical portions 311, the first vertical portions 311 are perpendicular to a curling direction A of the heating plate body 1, the first heating portions 31 comprise first heating proximal end potions 313 and first heating distal end portions 314, the first heating proximal end portions 313 are close to a control box 4 of the food warming board, and the first heating distal end portions 314 are far away from the control box 4 of the food warming board; and
second heating portions 32, wherein the second heating portions 32 comprise second vertical portions 321 arranged in parallel mutually and second connecting portions 322 connected between adjacent second vertical portions 321, the second vertical portions 321 are perpendicular to the curling direction A of the heating plate body 1, the second heating portions 32 comprise second heating proximal end portions 323 and second heating distal end portions 324, the second heating proximal end portions 323 are close to the control box 4 of the food warming board, the second heating distal end portions 324 are far away from the control box 4 of the food warming board, the first heating distal end portions 314 are connected to the second heating distal end portions 324, and the first heating portions and the second heating portions are arranged symmetrically.

Since the first vertical portions 311 and the second vertical portions 321 are perpendicular to the curling direction A of the heating plate body 1, the first vertical portions 311 and the second vertical portions 321 will not be curled during the curling process of the heating plate body 1, thereby avoiding curling of a long length of the heating wires 3, increasing the service life of the heating wires 3, and facilitating the curling operation, thereby improving the user experience.

The control box 4 is also fixed on the heating plate body 1, and the first heating proximal end portions 313 and the second heating proximal end portions 323 are connected to the control box 4.

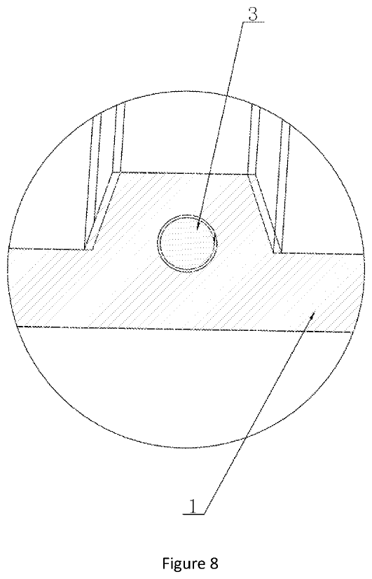

As shown in FIG. 8, this is a mounting method of the heating wires 3, the heating wires 3 are embedded in the heating plate body 1, and the heating wires 3 and the heating plate body 1 are integrally formed. Since the heating wires 3 are directly fixed (embedded) in the heating plate body 1 (the heating wires 3 and the heating plate body 1 are integrated), no additional gluing or other methods are required to fix it, so there is no gaps between the first heating wires 3 and the silica gel body, the product is more beautiful, and the production cost is low.

Supporting feet 2 are fixed to the lower side of the heating plate body 1, and the supporting feet 2 can play the role of the heating plate body 1.

As shown in FIGS. 1-7, this is a second mounting method of the heating wires 3, an upper side of the heating plate body 1 is provided with winding grooves 5 with openings facing upward, shapes of the winding grooves 5 correspond to shapes of the heating wires 3, the heating wires 3 are installed in the winding grooves 5, and heat conducting sheets 6 in contact with the heating wires 3 are fixed on the upper side of the heating plate body 1. The heat conducting sheets 6 are preferably made of metal.

Since the heat conducting sheets 6 are in direct contact with the heating wires 3, the heat conducting efficiency is high, the heat conducting sheets 6 can withstand higher temperatures, and the heating temperature of the whole food warming board can be increased, thereby improving the user experience. Furthermore, since the heat conducting sheets 6 transfers heat, heat efficiency thereof is high and the heat loss is small, and the power can be reduced compared to conventional silicone warming plates, thereby achieving energy saving.

The heat conducting sheets 6 are provided with flanges 7 around circumference thereof, and the upper side of the heating plate body 1 is provided with first gluing grooves 8 corresponding to the flanges 7, the flanges 7 are plugged into the first gluing grooves 8, and the flanges 7 are fixed in the first gluing grooves 8 by glue.

The upper side of the heating plate body 1 is provided with grooves 9 corresponding to the heat conducting sheets 6, the heat conducting sheets 6 are plugged into the grooves 9, and upper sides of the heat conducting sheets 6 and upper sides of the heating plate body 1 are in a same plane, so as to make the upper side of the food warm board flatter and more convenient to use.

The heat conducting sheets 6 are arranged in sequence along the curling direction of the heating plate body 1, so that the heat conducting sheets 6 will not affect the curling of the heating plate body 1.

A lower side of the heating plate body 1 is provided with wire passing grooves 10 which are communicated with the winding grooves 5. After winding, glue is applied to the wire passing grooves 10 to better fix the heating wires 3.

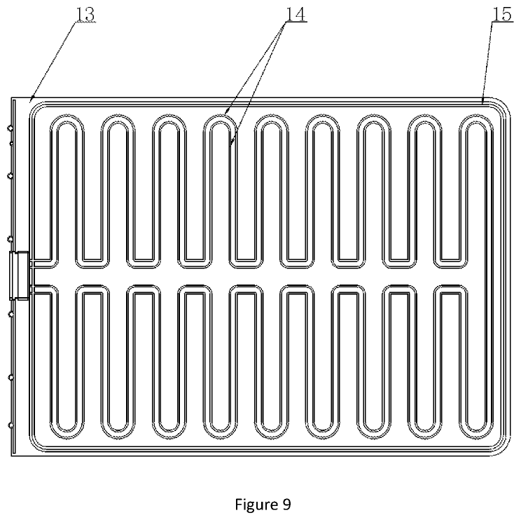

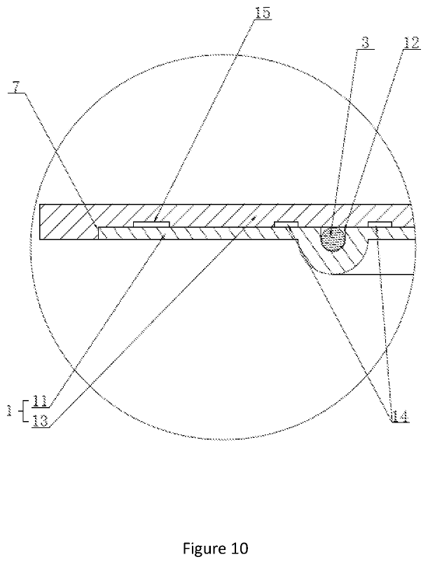

As shown in FIGS. 9-10, this is a third mounting method of the heating wires 3, the heating plate body 1 comprises:
a lower silicone plate 11, wherein an upper side of the lower silicone plate 11 is provided with lower winding grooves 12, shapes of the lower winding grooves 12 correspond to shapes of the heating wires 3, and the heating wires 3 are installed in the lower winding grooves 12; and
an upper silicone plate 13, wherein the upper silicone plate 13 is fixed to the upper side of the lower silicone plate 11, the heating wires 3 abut against a lower side of the upper silicone plate 13.

When the heating wires 3 are installed in the lower winding grooves 12, the heating wires 3 protrude out of the lower winding groove 12, and the upper silicone plate 13 is fixed on the upper side of the lower silicone plate 11. Since the upper silicone plate 13 and the lower silicone plate 11 have certain elasticity, the heating wires 3 are ensured to be in close contact with the lower side of the upper silicone plate 13, thereby increasing the heat transfer efficiency.

Two second gluing grooves 14 are provided on the lower side of the upper silicone plate 13, and the two second gluing grooves 14 are located on both sides of the lower winding grooves 12, glue is installed in the two second gluing grooves 14, and the upper silicone plate 13 and the lower silicone plate 11 are fixed together by glue. Such an arrangement can firmly connect the lower silicone plate 11 and the lower winding grooves 12 of the upper silicone plate 13 together, thereby preventing the heating wires 3 from moving out of the lower winding grooves 12.

The lower side of the upper silicone plate 13 is provided with outer glue grooves 15, and the lower winding grooves 12 are located in the outer glue grooves 15. Glue is installed in the outer glue grooves 15, and the upper silicone plate 13 and the lower silicone plate 11 are fixed together by glue, thereby increasing the firm connection between the lower silicone plate 11 and the upper silicone plate 13.

Although embodiments of the present invention have been shown and described, it will be appreciated by those skilled in the art that various changes, modifications, substitutions and variations may be made to the embodiments without departing from the principles and spirit of the present invention, and that the scope of the present invention is defined by the appended claims and their equivalents.

1. A food warming board, comprising: a heating plate body, wherein heating wires are installed in the heating plate body, and the heating wires comprise:
first heating portions, wherein the first heating portions comprise first vertical portions arranged in parallel mutually and first connecting portions connected between adjacent first vertical portions, the first vertical portions are perpendicular to a curling direction of the heating plate body, the first heating portions comprise first heating proximal end potions and first heating distal end portions, the first heating proximal end portions are close to a control box of the food warming board, and the first heating distal end portions are far away from the control box of the food warming board; and
second heating portions, wherein the second heating portions comprise second vertical portions arranged in parallel mutually and second connecting portions connected between adjacent second vertical portions, the second vertical portions are perpendicular to the curling direction of the heating plate body, the second heating portions comprise second heating proximal end portions and second heating distal end portions, the second heating proximal end portions are close to the control box of the food warming board, the second heating distal end portions are far away from the control box of the food warming board, and the first heating distal end portions are connected to the second heating distal end portions.

2. The food warming board according to claim 1, wherein the heating wires are embedded in the heating plate body, and the heating wires and the heating plate body are integrally formed.

3. The food warming board according to claim 1, wherein an upper side of the heating plate body is provided with winding grooves with openings facing upward, shapes of the winding grooves correspond to shapes of the heating wires, the heating wires are installed in the winding grooves, and heat conducting sheets in contact with the heating wires are fixed on the upper side of the heating plate body.

4. The food warming board according to claim 3, wherein the heat conducting sheets are provided with flanges around circumference thereof, and the upper side of the heating plate body is provided with first gluing grooves corresponding to the flanges, the flanges are plugged into the first gluing grooves, and the flanges are fixed in the first gluing grooves by glue.

5. The food warming board according to claim 3, wherein the upper side of the heating plate body is provided with grooves corresponding to the heat conducting sheets, the heat conducting sheets are plugged into the grooves, and upper sides of the heat conducting sheets and upper sides of the heating plate body are in a same plane.

6. The food warming board according to claim 3, wherein the heat conducting sheets are arranged in sequence along the curling direction of the heating plate body.

7. The food warming board according to claim 3, wherein a lower side of the heating plate body is provided with wire passing grooves which are communicated with the winding grooves.

8. The food warming board according to claim 1, wherein the heating plate body comprises:
a lower silicone plate, wherein an upper side of the lower silicone plate is provided with lower winding grooves, shapes of the lower winding grooves correspond to shapes of the heating wires, and the heating wires are installed in the lower winding grooves; and
an upper silicone plate, wherein the upper silicone plate is fixed to the upper side of the lower silicone plate, the heating wires abut against a lower side of the upper silicone plate.

9. The food warming board according to claim 8, wherein two second gluing grooves are provided on the lower side of the upper silicone plate, and the two second gluing grooves are located on both sides of the lower winding grooves, glue is installed in the two second gluing grooves, and the upper silicone plate and the lower silicone plate are fixed together by glue.

10. The food warming board according to claim 1, wherein supporting feet are fixed on a lower side of the heating plate body.
